(19) United States
(12) Patent Application Publication
(10) Pub. No.: US 2026/0166633 A1
(43) Pub. Date: Jun. 18, 2026

(54) Drill

(71) Applicant: Robert Bosch GmbH, Stuttgart (DE)

(72) Inventors: Martina Spahni, Ruttenen, Solothurn (CH); Immo Juergens, Zuchwil, Solothurn (CH); Rafael Staehli, Evilard (CH); Milan Bozic, Luterbach (CH)

(21) Appl. No.: 19/127,106

(22) PCT Filed: Nov. 2, 2023
(86) PCT No.: PCT/EP2023/080504

§ 371 Date: May 3, 2025

(30) Foreign Application Priority Data
Nov. 7, 2022 (DE) 10 2022 211 701.8
Oct. 31, 2023 (DE) 10 2023 210 822.4

(51) Int. Cl. B23B 51/02

(52) U.S. Cl. CPC B23B 51/02

(57) ABSTRACT

A drill, in particular for drilling metal, includes a cutting part which has a drill point and at least two helical grooves which extend from the drill point to an end of the cutting part opposite the drill point, and in the region of the drill point, each lead into a thinned region. The thinned regions form a cross-grinding. The thinned regions each have an opening angle of less than 30°.

### PRIOR ART

Various drills are already known. One type of drill has a drill point with a so-called cross-grinding. Part of the cross-grinding process involves so-called thinned regions, which have an angle of 30° at the drill point.

### DISCLOSURE OF THE INVENTION

The invention relates to a drill, in particular a twist drill or a step drill, preferably for drilling metal, having a cutting part which has a drill point and at least two helical grooves which extend from the drill point to one of the opposite ends of the cutting part and, in the region of the drill point, each lead into a thinned region, wherein the thinned regions form a cross-grinding.

It is proposed that the thinned regions each have an opening angle of less than 30°.

In particular, in an embodiment of the drill as a step drill, the cutting part can be followed by one or more further cutting parts. The further cutting parts can also have one or more helical grooves or be designed without such.

The drill is preferably intended for use in a hand drill. For this purpose, the drill preferably has a tool shank which is connected in particular to the cutting part or one of the further cutting parts and is intended to be accommodated in a tool holder, in particular a chuck, of the hand drill.

The cutting part preferably has a center axis. The center axis is, in particular, a geometric central axis and/or axis of symmetry. In particular, at least the cutting part is designed to be rotationally symmetrical with respect to the center axis. The drill can be designed to be driven in rotation about the center axis for the purpose of drilling a hole by means of the drill.

In particular, the helical grooves each have a leading and a trailing partial surface. The leading partial surface and the trailing partial surface are adjacent to one another along a dividing line. The dividing line can be formed by the points of the helical groove that have a smallest distance to the center axis along the helical groove. The dividing line can wind around the center axis with a pitch angle that corresponds to the helix angle, in particular in a spiral. Advantageously, the leading partial surface has normal vectors at any points, which each have at least one partial component parallel to the center axis, which points away from the drill point. Advantageously, the trailing partial surface has normal vectors at any points, which each have at least one partial component parallel to the center axis, which points towards the drill point. The partial surfaces of the helical grooves each have a common edge with a lateral surface of the cutting part. At least the edge of the respective leading partial surface can have a reinforcement, a coating and/or a special grinding and/or can have been subjected to a separate hardening process.

The leading partial surface may end at the drill point in a main cutting element. The trailing partial surface ends in particular in the region of the drill point at the thinned region. The trailing partial surface and the thinned region meet at a transition edge. Alternatively, embodiments with a smooth transition between the trailing partial surface and the thinned region are conceivable. The thinned region can form a first common edge with a part of the leading partial surface, which extends away from the drill point from one of the ends of the main cutting element close to the center axis.

The drill point preferably has a conical or cone-like point grind. The drill point can have a point angle of 135°. Preferably, the drill point has a point angle between 135° and 140°, preferably between 135° and 138°.

The opening angle of the thinned region can be understood as the angle of intersection between the center axis and a plane that is tangent to the thinned region at the end facing the drill point. The thinned regions can each be formed by a plane ground section. Alternatively, the thinned regions can be formed by a hollow ground, in particular a round hollow ground.

The term “intended” is to be understood in particular as specially programmed, designed and/or equipped. The fact that an object is intended for a specific function should be understood in particular to mean that the object fulfills and/or executes this specific function in at least one application and/or operating state.

In particular, a high durability can be achieved by the embodiment of the drill according to the invention. In particular, a chip clearance at the drill point can be enlarged in order to achieve an improved cutting, in particular at an auxiliary cutting element of the drill point, and/or an improved chip removal.

Furthermore, it is proposed that the helical grooves, at least near the drill point, have a helix angle, also known as a rake angle, of more than 30°. Preferably, the helix angle is constant for the entire respective helical groove. Alternatively, it is conceivable that the helix angle varies along the respective helical groove.

This can in particular achieve reduced power requirements for a drill drive, which is particularly advantageous when using the drill in a hand drill. Furthermore, a reduced sensitivity of the drill to a drilling angle and/or a uniform chip removal, in particular with regard to changing drilling angles, as they arise in particular by wobbling or changing holding position of the hand drill by a user, can be achieved.

The helical grooves advantageously have a helix angle between 35° and 45°, preferably between 40° and 45°. The thinned regions can each have an opening angle between 18° and 28°. Preferably, the thinned regions each have an opening angle of 27°.

In particular, the combination of a reduced helix angle and a reduced opening angle of the thinned regions can achieve an increase in the chip clearance.

For example, an auxiliary cutting element is formed at each of the thinned regions, which is arranged between the main cutting element and the center axis. In particular, the auxiliary cutting element and the main cutting element form an angle between 80° and 130°, in particular between 90° and 120°. In particular, the auxiliary cutting element extends from an end of the main cutting element that is close to the center axis to the center axis or to an axis that is parallel to the center axis and at a distance from the center axis that is less than 3%, in particular less than 2%, advantageously less than 1%, of a diameter of the cutting part. This can, in particular, achieve good centering of the drill.

Furthermore, it is proposed that the auxiliary cutting element has a rake angle between 5° and 30°. In particular, the rake angle of the auxiliary cutting element is to be understood as a cutting angle of a plane in which the auxiliary cutting element and the first common edge lie, with the center axis. In particular, this can achieve a good chip removal effect of the auxiliary cutting element. According to further embodiments, it is conceivable that the auxiliary cutting element has a rake angle of less than 5°, in particular between 0° and 5°.

The auxiliary cutting element can have a length corresponding to at least 5%, in particular at least 7%, of a diameter of the cutting part. This can be used in particular to create a large chip clearance.

Furthermore, the drill point can have a clearance angle between 5° and 15°, which can be used to achieve a particularly advantageous cutting effect.

The drill point advantageously comprises a cross cutting element which has a length corresponding to 0% to 5% of a diameter of the cutting part. Advantageously, the cross cutting element is shorter than 4%, in particular shorter than 2%, preferably shorter than 1% of the diameter of the cutting part. The cross cutting element can be located between the ends of the auxiliary cutting elements close to the center axis. The diameter of the cutting part should be understood to mean, in particular, the diameter of the smallest imaginary circular cylinder that completely envelops the cutting part.

The length of the cross cutting element is preferably 5% to 15%, preferably 5% to 10%, of the diameter of the drill point.

It is further proposed that the drill point has at least one cross cutting element, which extends at least substantially perpendicular to a center axis over the center axis. The cross cutting element forms in particular a point of the drill point. Preferably, the cross cutting element extends perpendicular to the center axis of the drill. The cross cutting element extends in particular parallel to a longitudinal axis of the drill through a geometric center of the drill. The length of the cross cutting element is in particular more than 1%, preferably more than 2%, of a diameter of the drill. Preferably, the length of the cross cutting element is less than 15%, preferably less than 10%, of a diameter of the drill. This can be used to provide an advantageous drill point.

Furthermore, it is proposed that the auxiliary cutting elements are at least substantially parallel to the cross cutting element, offset with respect to the cross cutting element. The two auxiliary cutting elements are arranged in particular on opposite sides of the cross cutting element. “Substantially parallel” is to be understood here in particular to mean an orientation of a direction relative to a reference direction, in particular in a plane, wherein the direction has a deviation relative to the reference direction that is in particular less than 8°, advantageously less than 5° and particularly advantageously less than 2°. The auxiliary cutting elements are each directly adjacent to one of the main cutting elements, wherein the auxiliary cutting elements are angled with respect to the main cutting elements. Preferably, the auxiliary cutting element of a first cutting wing is adjacent to the thinned region of a second cutting wing, while the auxiliary cutting element of the second cutting wing is adjacent to the thinned region of the first cutting wing. In particular, this allows for the provision of an advantageous, efficient drill point. In particular, a favorable drilling result can be achieved in different materials. In particular, an advantageously large angle of a secondary chisel surface can be provided.

It is also proposed that the drill point has at least two further thinned regions directly adjacent to the main cutting element, which each form a partial rake face and are each curved concavely around an axis that runs at least substantially parallel to the respectively adjacent main cutting element. In particular, the further thinned regions form a furrow and/or groove. Preferably, the further thinned regions each form a recess in the helical groove. Preferably, the thinned regions extend substantially parallel to the extent of the respectively adjacent main cutting element. In particular, the main cutting elements have an advantageously constant wedge angle over their entire extent, adjacent to the further thinned regions. The wedge angle of the main cutting elements is between 62° and 66° over the entire cutting edge. The wedge angle is preferably advantageously aggressive in a radially outer area of the main cutting elements. The rake angle of the main cutting element is preferably between 11° and 17°. This can result in a higher cutting force and a lower load. Preferably, the drill point has an advantageously short free surface, which in particular results in low friction.

It is further proposed that a radius of curvature of the further thinned regions is substantially smaller than a radius of a concave curvature of the helical grooves. Preferably, a radius of curvature of the further thinned regions is not constant and can change over the course. Preferably, the radius of curvature of the further thinned regions changes continuously. Preferably, the radius of curvature of the further thinned regions is at least substantially constant. It is further proposed that a radius of curvature of the further thinned regions is less than 2 mm. Preferably, a radius of curvature of the further thinned regions is less than 2 mm at any point along the main cutting element. Preferably, the radius of curvature of the further thinned regions is less than 1.5 mm at any point along the main cutting element, and less than 1 mm is particularly preferred. Preferably, the radius of curvature of the further thinned regions is between 0.75 mm and 0.9 mm in each case. In particular, this allows for the provision of an advantageous, efficient drill point. In particular, an advantageous wedge angle and/or rake angle of the main cutting elements can be provided.

It is further proposed that the other thinned regions each have a maximum thinned region length that is greater than one main cutting element length of the main cutting elements. Preferably, the other thinned regions have an identical maximum thinned region length. In particular, the thinned region length corresponds to a maximum extension of the respective other thinned region. Preferably, the length of the further thinned regions is at least 110%, preferably at least 120%, and particularly preferably at least 140%, of the length of the main cutting elements. Preferably, the length of the main cutting elements of the main cutting elements is 1.755 mm for a drill point diameter of at least approximately 4 mm. Preferably, the length of the further thinned regions is more than 2 mm, preferably more than 2.2 mm and particularly preferably more than 2.3 mm, with the drill point diameter being at least approximately 4 mm. Preferably, the length of the further thinned regions is at least approximately 2.5 mm for a drill point diameter of at least approximately 4 mm. This can be particularly advantageous for further thinned region.

Preferably, the length of each auxiliary cutting element is less than 30%, preferably less than 20%, and more preferably less than 15%, of a main cutting element length of the main cutting elements. The length of the auxiliary cutting elements is preferably at least approximately 0.23 mm for a drill point diameter of at least approximately 4 mm. The cross cutting element preferably has a length of less than 0.4 mm, preferably at least approximately 0.35 mm, for a drill point diameter of at least approximately 4 mm.

An angle between the main cutting element and the auxiliary cutting element of a cutting wing is in particular between 140° and 160°. Preferably, the angle between the main cutting element and the auxiliary cutting element of a cutting wing is at least approximately 151°. An angle between the cross cutting element and the auxiliary cutting element is in particular between 140° and 170°. Preferably, the angle between the cross cutting element and the auxiliary cutting element is at least approximately 155°. An angle between the main cutting element and the cross cutting element is in particular between 120° and 140°. Preferably, the angle between the main cutting element and the cross cutting element is at least approximately 128°. An angle between a primary relief face and a Z-axis is in particular between 20° and 25°, preferably at least approximately 22°. An angle between a secondary relief face and a Z-axis is in particular between 50° and 60°, preferably at least approximately 56.5°. An angle between the primary flank face and the secondary flank face is in particular between 120° and 140°, preferably at least approximately 130°. An angle between the further thinned region and the main cutting element of a cutting wing is preferably between 5° and 15°. Preferably, the angle between the wider thinned region and the main cutting element of a cutting wing is at least approximately 10°. Furthermore, the point of the drill point has an opening angle between 120° and 140°. Preferably, the opening angle of the point is at least approximately 130°, preferably exactly 129.8°.

Furthermore, a method for manufacturing a drill as described above is proposed. For example, the method comprises providing a blank. The method can also include cutting the helical grooves into the blank at a predefined helix angle, in particular more than 30°. Furthermore, the method can comprise sharpening one end of the blank, wherein the tip is given a conical or frusto-conical grind, in particular. The thinning can also comprise grinding thinned regions at a predefined opening angle, in particular less than 30°.

The drill according to the invention is not limited to the application and embodiment described above. In particular, the drill according to the invention can have a number of individual elements, components and units as well as method steps that deviates from a number mentioned herein for fulfillment of a function described herein. Additionally, regarding the ranges of values indicated in this disclosure, values lying within the limits specified hereinabove are also provided to be considered as disclosed and usable as desired.

### DRAWINGS

Further advantages follow from the description of the drawings below. Two exemplary embodiments of the invention are shown in the drawings. The drawing, the description, and the claims contain numerous features in combination. A person skilled in the art will appropriately also consider the features individually and combine them into additional advantageous combinations.

The figures each show schematically:

FIG. 1 a side view of a drill according to the invention,

FIG. 2 a side view of a drill point of the drill according to FIG. 1,

FIG. 3 a perspective view from above of the drill point according to FIG. 2,

FIG. 4 a detailed view of the perspective view from above according to FIG. 3,

FIG. 5 a frontal view of the drill point according to FIG. 2,

FIG. 6 a further side view of the drill point according to FIG. 2,

FIG. 7 a third side view of the drill point according to FIG. 2,

FIG. 8 a side view of an alternative drill according to the invention,

FIG. 9 a perspective view from above of a drill point of the alternative drill according to the invention, as shown in FIG. 8,

FIG. 10 a perspective view from above of the drill point of the alternative drill according to the invention, as shown in FIG. 8,

FIG. 11 a perspective side view from above of the drill point of the alternative drill according to the invention, as shown in FIG. 8,

FIG. 12 a view from above of the drill point of the alternative drill according to the invention, as shown in FIG. 8,

FIG. 13 a perspective side view from above of the drill point of the alternative drill according to the invention, as shown in FIG. 8, and

FIG. 14 a partial cutout view of the drill point as shown in FIG. 13.

### DESCRIPTION OF THE EXEMPLARY EMBODIMENTS

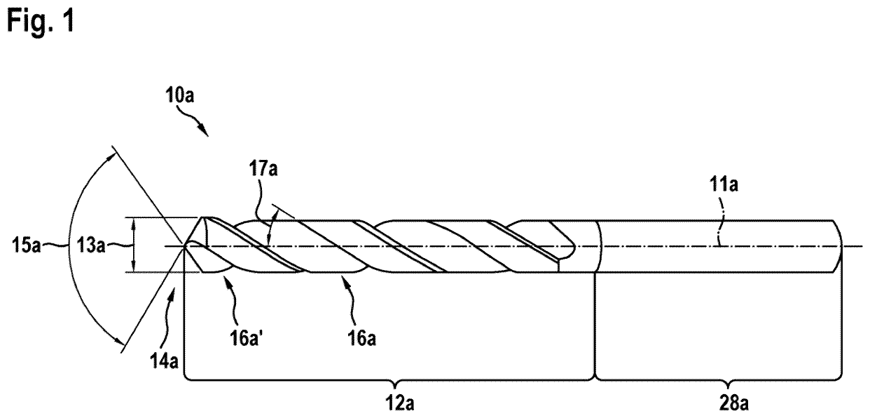

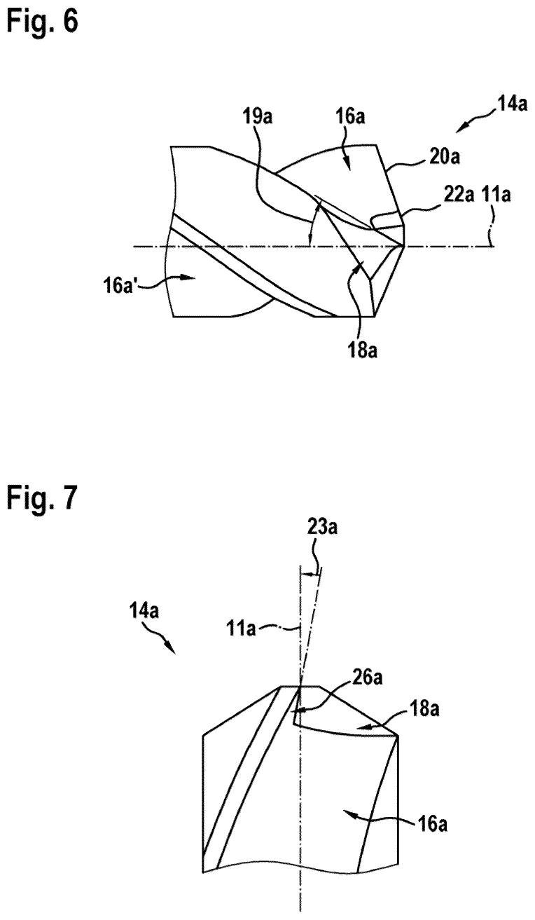

FIGS. 1 through 7 show a drill 10a and various detailed views of the drill 10a. The drill 10a is a twist drill. Equivalent embodiments may also be applied to a step drill. The drill 10a is a metal drill. The drill 10a is for metal working, in particular for drilling metal.

The drill 10a has a cutting part 12a. The cutting part 12a has a drill point 14a at one end. The drill point 14a has a point grind. The point grind has a point angle 15a of 135°.

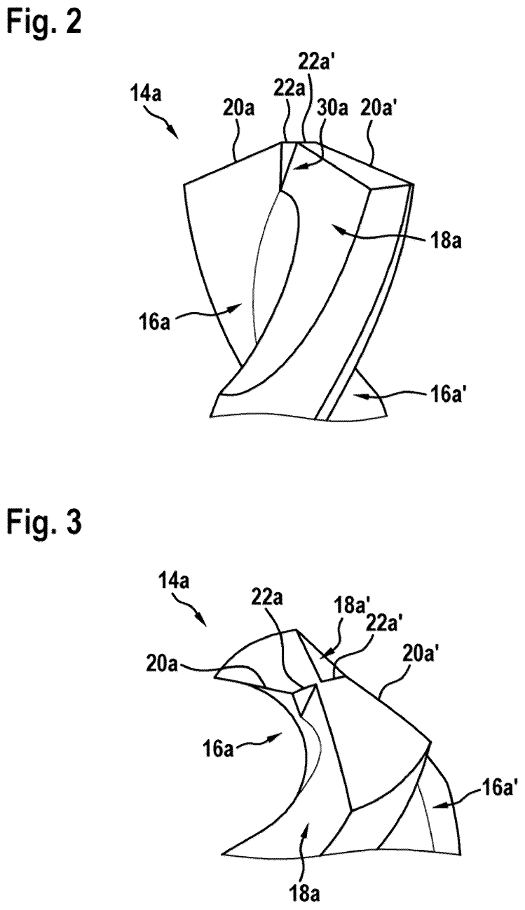

The cutting part 12a has a cylindrical basic shape. The cutting part 12a has a center axis 11a. The cutting part 12a is rotationally symmetrical with respect to the center axis 11a. The cutting part 12a also has two helical grooves 16a, 16′a which extend from the drill point 14a to an end of the cutting part 12a opposite the drill point 14a. The helical grooves 16a, 16′a each lead, in the region of the drill point 14a, into a thinned region 18a, 18′a (see FIGS. 2 to 7).

The thinned regions 18a, 18′a form a cross-grinding. The thinned regions 18a, 18′a are also called surface grinding. The thinned regions 18a, 18′a each have an opening angle 19a of less than 30° (see 6). The opening angle 19a of the thinned regions 18a, 18′a is between 18° and 28°. The opening angle 19a of the thinned regions 18a, 18′a is 27°.

According to alternative embodiments, the opening angle is less than 27°. This can achieve improved cutting behavior, in particular at the expense of durability.

The helical grooves 16a, 16′a have a helix angle 17a of more than 30° near the drill point 14a. The helix angle 17a of the helical grooves 16a, 16′a is constant along the entire cutting part 12a. The helix angle 17a is between 35° and 45°. The helix angle 17a is 45°.

The leading partial surfaces of the helical grooves 16a, 16′a end at the drill point 14a in a main cutting element 20a, 20′a.

At the thinned regions 18a, 18′a, an auxiliary cutting element 22a, 22′a is formed in each case, which is arranged between the respective main cutting element 20a and the center axis 11a.

The auxiliary cutting elements 22a, 22′a each have a rake angle 23a between 5° and 30° (see FIG. 7).

The drill point 14a has a clearance angle between 5° and 15° (not shown in more detail).

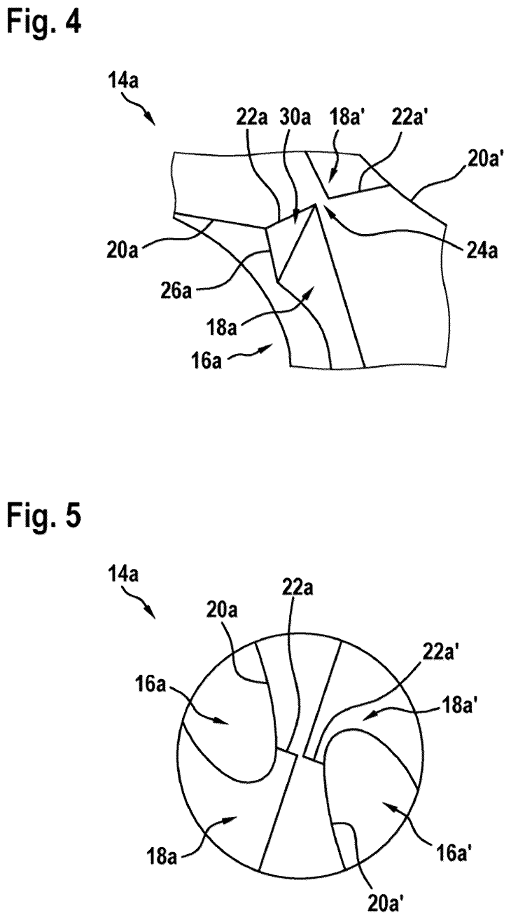

The drill point 14a has a cross cutting element 24a, which has a length between 0% and 5% of a diameter 13a of the cutting part 12a (see FIG. 4). The diameter 13a of the cutting part 12a is, for example, 6 mm. According to alternative embodiments, the cutting part can have diameters between 1 mm and 20 mm. The cross cutting element 24a can have a cross cutting angle between 125° and 135°.

The auxiliary cutting element 22a and an edge 26a form a triangle. The triangle defines a chip clearance 30a. The edge 26a extends from a first point, at which the respective auxiliary cutting element 22a, 22′a and the respective main cutting element 20a, 20′a meet, away from the drill point 14a to a second point. At the edge 26a, the respective thinned region 18a, 18′a meets the leading partial surface of the respective helical groove 16a, 16′a. At the second point, a dividing line between the thinned region 18a, 18′a and the respective leading partial surface has a kink, in particular between 70°-110°. One of the sizes of the triangle and thus of the chip clearance 30a is determined by the length of the auxiliary cutting element 22a, 22′a, the opening angle 19a of the thinned region 18a, 18′a and the helix angle 17a of the corresponding helical groove 16a, 16′a. An increase in the helix angle 17a compared to a helix angle of 45° and a reduction in the opening angle 19a compared to an opening angle of 30° causes an enlargement of the triangle and thus of the chip clearance 30a. A large chip clearance 30a is particularly useful for improved chip removal, which can lead to improved centering of the drill 10a and a longer service life for the drill 10a and the drill point 14a.

The first point is 0.069 mm parallel to the center axis 11a from a point of the drill 10a. The first point is removed from the center axis 11a by 0.71 mm. The second point, parallelly to the center axis 11a, is removed from the point of the drill 10a by 0.902 mm. The second point, parallelly to the center axis 11a, is removed from the point of the drill 10a by 0.554. The triangle defining chip clearance 30a has an area of 0.975mm².

According to alternative embodiments, the first point, parallelly to the center axis, can be removed from the point of the drill by between 0.061 mm and 0.137 mm, in particular by between 0.06664 mm and 0.06936 mm, preferably by between 0.06664 mm and 0.069 mm. According to alternative embodiments, the first point can be removed from the center axis by between 0.692 mm and 0.74 mm, in particular by between 0.6958 mm and 0.7242 mm. The second point, parallelly to the center axis, can be removed from the point of the drill 10a by between 0.88396 mm and 2.09 mm, in particular by between 0.88396 mm and 0.92004 mm. Alternatively, the second point may be removed from the center axis 11a by between 0.51 mm and 0.632 mm, in particular by between 0.54292 mm and 0.56508 mm. The triangle defining the chip clearance 30a can, according to alternative embodiments, have an area between 0.9314 mm² and 1.385 mm² , in particular between 0.9555 mm² and 0.9945 mm². For drills with a larger or smaller diameter, the triangle would be scaled accordingly.

A tool shank 28a is connected to the cutting part 12a. The tool shank 28a may have the same diameter as the cutting part 12a. The tool shank 28a may be cylindrical and smooth or may have connecting elements designed to interact with a tool holder of a drill.

The cutting part 12a may have a core thickness between 10% and 25%, in particular between 15% and 20%, of the diameter 13a of the cutting part 12a. The cutting part 12a has a core thickness of 1.1 mm. The main cutting elements 20a, 20′a have a main cutting element offset between 10% and 20%, in particular between 12% and 17%, of the diameter 13a of the cutting part 12a. The main cutting elements 20a, 20′a have a main cutting element offset of 0.86 mm. A length of the auxiliary cutting elements 22a, 22′a is limited in particular by the size of the main cutting element offset. The auxiliary cutting elements 22a, 22′a have an auxiliary cutting element offset between 0% and 2.5% of the diameter 13a of the cutting part 12a. The auxiliary cutting elements 22a, 22′a have an auxiliary cutting element offset between 0.01 mm and 0.15 mm.

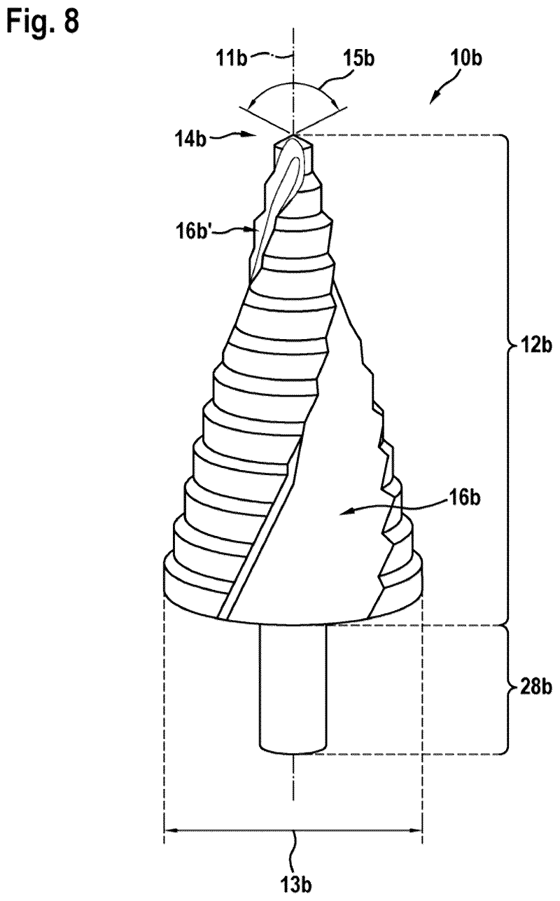

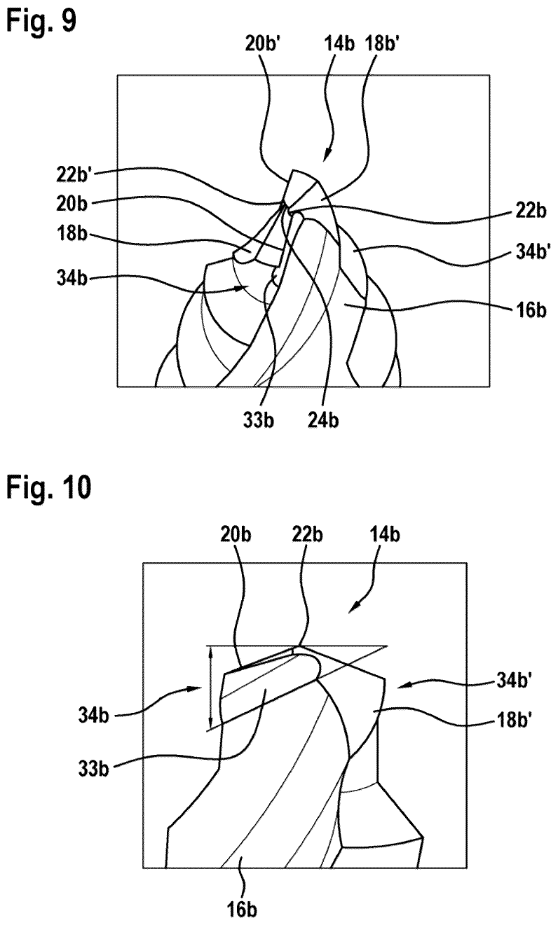

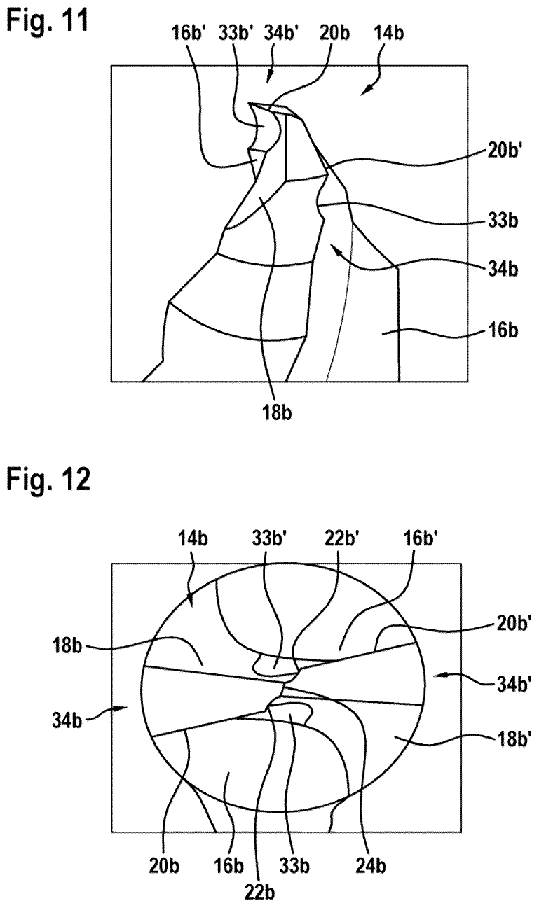

FIGS. 8 through 14 show a further exemplary embodiment of the invention. The following descriptions are essentially limited to the differences between the exemplary embodiments, whereby reference can be made to the description of the exemplary embodiment in FIGS. 1 to 7 with regard to components, features and functions that remain the same. To distinguish the exemplary embodiments, the letter a in the reference numerals of the exemplary embodiment in FIGS. 1 to 7 is replaced by the letter b in the reference numerals of the exemplary embodiment in FIGS. 8 to 14. With regard to components that are labeled identically, in particular with regard to components with the same reference numerals, reference can also be made to the drawings and/or the description of the exemplary embodiment in FIGS. 1 through 7.

FIG. 8 shows a drill 10b. The drill 10b is formed by a step drill. The drill 10b is a metal drill. The drill 10b is for metal working, in particular for drilling metal.

The drill 10b has a cutting part 12a. The cutting part 12b has a drill point 14b at one end. The drill point 14b has a point grind. The point grind has a point angle 15b of 135° to 140° (nominal dimension).

The cutting part 12b has a conical base shape. The cutting part 12b has a center axis 11b. The cutting part 12b is rotationally symmetrical with respect to the center axis 11b. The center axis 11b is formed by a rotation axis of the drill 10b. The cutting part 12b also has two helical grooves 16b, 16′b which extend from the drill point 14b to an end of the cutting part 12b opposite the drill point 14b. The helical grooves 16b, 16′b lead, in the region of the drill point 14b, in each case to a thinned region 18b, 18′b and a further thinned region 33b, 33′b.

The thinned regions 18b, 18′b form a cross-grinding. The thinned regions 18b, 18′b are also called surface grinding. The thinned regions 18b, 18′b each have an opening angle 19b of less than 30°. The opening angle 19b of the thinned regions 18b, 18′b is between 18° and 28°. The opening angle 19b of the thinned regions 18b, 18′b is 27°.

The helical grooves 16b, 16′b have a helix angle 17b of more than 30° near the drill point 14b. The helix angle 17b of the helical grooves 16b, 16′b is constant along the entire cutting part 12b. The helix angle 17b is between 35° and 45°. The helix angle 17b is 45°.

At the thinned regions 18b, 18′b, an auxiliary cutting element 22b, 22′a is formed in each case, which is arranged between the respective main cutting element 20b and the center axis 11b. The auxiliary cutting elements 22b, 22′b each have a rake angle 23b between 5° and 30°.

The drill point 14b also has a cross cutting element 24b, which extends substantially perpendicular to a center axis 11b over the center axis 11b. The cross cutting element 24b forms a point of the drill point 14b. The cross cutting element 24b extends perpendicular to the center axis 11b of the drill 10b. The center axis 11b extends parallel to a longitudinal axis of the drill 10b through a geometric center of the drill 10b. The diameter 13b of the cutting part 12b is, for example, 6 mm. According to alternative embodiments, the cutting part 12b can have a diameter between 1 mm and 20 mm. The cross cutting element 24b can have a cross cutting angle between 125° and 135°. The length of the cross cutting element 24b is more than 1%, preferably more than 2%, of a diameter of the drill 10b. Preferably, the length of the cross cutting element 24b is less than 15%, preferably less than 10%, of a diameter of the drill 10b.

The auxiliary cutting elements 22b, 22′b are substantially parallel to the chisel edge 31b, offset with respect to the cross cutting element 24b (see FIG. 12). The two auxiliary cutting elements 22b, 22′b are arranged on opposite sides of the cross cutting element 24b. The auxiliary cutting elements 22b, 22′b are each directly adjacent to one of the main cutting elements 20b, 20′b, wherein the auxiliary cutting elements 22b, 22′b are angled with respect to the main cutting elements 20b, 20′b. The auxiliary cutting elements 22b, 22′b are substantially parallel to one another. The auxiliary cutting elements 22b, 22′b are each arranged on the side of the cross cutting element 24b on which the main cutting element 20b, 20′b is also arranged, which is adjoined by the respective auxiliary cutting element 22b, 22′b. Furthermore, the auxiliary cutting element 22b of a first cutting wing 34b adjoins the thinned region 18′b of a second cutting wing 34′b, while the auxiliary cutting element 22′b of the second cutting wing 34′b adjoins the thinned region 18b of the first cutting wing 34b. The thinned regions 18b, 18′b run out in a triangle in each case, in particular, to the auxiliary cutting elements 22b, 22′b.

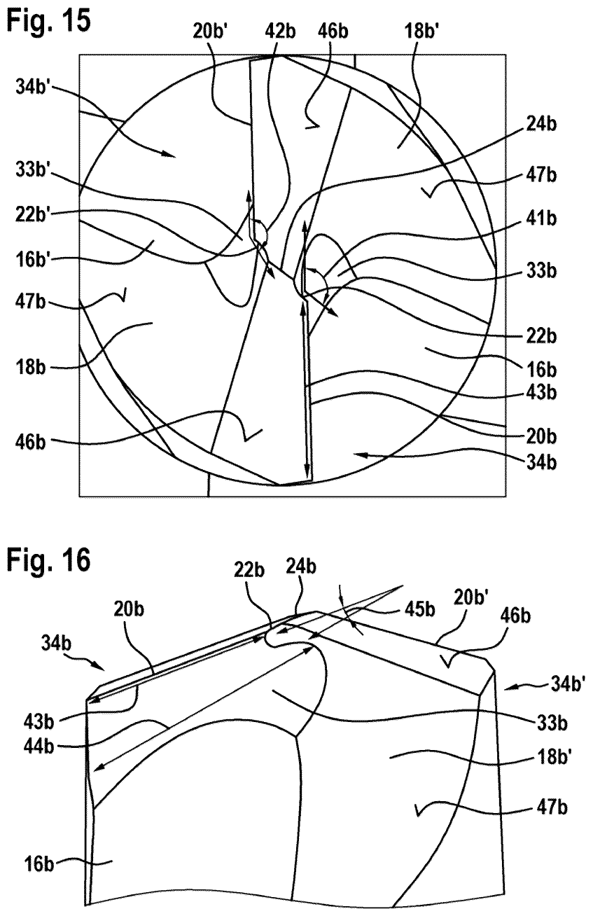

The drill point 14b has a clearance angle 35b, 36b between 5° and 15°. The drill point 14b has a clearance angle 35b, 36b between 7° and 15° at the main cutting element 20b, 20′b. The main cutting elements 20b, 20′b, viewed radially from the outside, each have a clearance angle 35b between 7.5° and 9° after 20% of the edge length of the respective main cutting element 20b, 20′b. Furthermore, the main cutting elements 20b, 20′b, viewed radially from the outside, each have a clearance angle 36b between 12° and 15° after 60% of the edge length of the respective main cutting element 20b, 20′b (see FIG. 14).

The leading partial surfaces of the helical grooves 16b, 16′b end via the further thinned regions 33b, 33′b at the drill point 14b in each case in the main cutting element 20b, 20′b and the auxiliary cutting element 22b, 22′b. The drill point 14b has two further thinned regions 33b, 33′bdirectly adjacent to the main cutting elements 20b, 20′b, which each form a partial rake face and are each curved concavely around an axis that runs at least substantially parallel to the respectively adjacent main cutting element 20b, 20′b. The further thinned regions 33b, 33′b in particular form a furrow and/or groove. The further thinned regions 33b, 33′b each form a recess in one of the helical grooves 16b, 16′b. The thinned regions 33b, 33′b extend substantially parallel to the extension of the respectively adjacent main cutting element 20b, 20′b. In particular, the axis around which the thinned regions 33b, 33′b are curved is inclined at an angle of between 65° and 70° to the center axis 11b (see FIG. 10). The main cutting elements 20b, 20′b have a favorably constant wedge angle 37b, 38b, in particular over their entire length, adjacent to the further thinned regions 33b, 33′b. The wedge angle 37b, 38b of the main cutting elements 20b, 20′b is between 62° and 66° over the entire cutting edge. The wedge angle 37b, 38b is advantageously aggressive in what is a radially outer area of the main cutting elements 20b, 20′b. The main cutting elements 20b, 20′b, viewed radially from the outside, each have a wedge angle 37b between 64° and 66° after 20% of the edge length of the respective main cutting element 20b, 20′b. Furthermore, the main cutting elements 20b, 20′b, viewed radially from the outside, have a wedge angle 38b between 64° and 67° after 60% of the edge length of the respective main cutting element 20b, 20′b (see FIG. 14). A rake angle 39b, 40b of the main cutting elements 20b, 20′b is between 10° and 18°. The main cutting elements 20b, 20′b, viewed radially from the outside, each have a rake angle 39b between 16° and 18° after 20% of the edge length of the respective main cutting element 20b, 20′b. Furthermore, the main cutting elements 20b, 20′b, viewed radially from the outside, each have a rake angle 40b between 11° and 12° after 60% of the edge length of the respective main cutting element 20b, 20′b (see FIG. 14).

The other thinned regions 33b, 33′b extend along the entire main cutting element 20b, 20′b of the respective cutting wing 34b, 34′b. The further thinned regions 33b, 33′b each project into the thinned region 18b, 18b′ of the opposite cutting wing 34b, 34′b and extend beyond the center.

The other thinned regions 33b, 33′b each have a maximum thinned region length 44b that is greater than a main cutting element length 43b of the main cutting elements 20b, 20′b. The thinned region length 44b corresponds to a maximum extension of the respective other thinned region 33b, 33′b. The thinned region length 44b of the further thinned regions 33b, 33′b is at least 110%, preferably at least 120% and particularly preferably at least 140% of the main cutting element length 43b of the main cutting elements 20b, 20′b. The main cutting element length 43b of the main cutting elements is 1.755 mm for a drill point diameter 14b of at least approximately 4 mm. The thinned region length 44b of the further thinned regions 33b, 33′b is more than 2 mm, preferably more than 2.2 mm and particularly preferably more than 2.3 mm, with a drill point diameter 14b of at least approximately 4 mm. The thinned region length 44b of the further thinned regions 33b, 33′b is at least approximately 2.5 mm for a drill point diameter of 14b of at least approximately 4 mm.

The length of each auxiliary cutting element 22b, 22′b is less than 30%, preferably less than 20% and more preferably less than 15% of a main cutting element length 43b of the main cutting elements 20b, 20′b. The length of the auxiliary cutting elements 22b, 22′b is at least approximately 0.23 mm for a diameter of the drill point 14b of at least approximately 4 mm. Preferably, the length of the cross cutting element is less than 0.4 mm, preferably at least approximately 0.35 mm, for a drill point diameter of 14b of at least approximately 4 mm.

An angle 42b between the main cutting element 20b, 20′b and the auxiliary cutting element 22b, 22′b of a cutting wing 34b, 34′b is between 140° and 160°. Preferably, the angle 42b between the main cutting element 20b, 20′b and the auxiliary cutting element 22b, 22′b of a cutting wing 34b, 34′b is at least approximately 151°. An angle 41b between the cross cutting element 24b, 24′b and the auxiliary cutting element 22b, 22′b is in particular between 140° and 170°. Preferably, the angle 41b between the cross cutting element 24b, 24′b and the auxiliary cutting element 22b, 22′b is at least approximately 155°. An angle between the main cutting element 20b, 20′b and the cross cutting element 24b, 24′b is in particular between 120° and 140°. Preferably, the angle between the main cutting element 20b, 20′b and the cross cutting element 24b, 24′b is at least approximately 128°. An angle between a primary clearance surface 46b and a Z-axis is in particular between 20° and 25°, preferably at least approximately 22°. An angle between a secondary clearance surface 47b and a Z-axis is in particular between 50° and 60°, preferably at least approximately 56.5°. An angle between the primary relief face 46b and the secondary relief face 47b is in particular between 120° and 140°, preferably at least approximately 130°. Preferably, an angle between the further thinned region 33b, 33′b and the main cutting element 20b, 20′b of a cutting wing 34b, 34′b is between 5° and 15°. Preferably, the angle between the further thinned region 33b, 33′b and the main cutting element 20b, 20′b of a cutting wing 34b, 34′b is at least approximately 10°. Furthermore, the point of the drill point 14b has an opening angle between 120° and 140°. Preferably, the opening angle of the point is at least approximately 130°, preferably exactly 129.8°.

The Z-axis corresponds to an axis of rotation of the drill 10b.

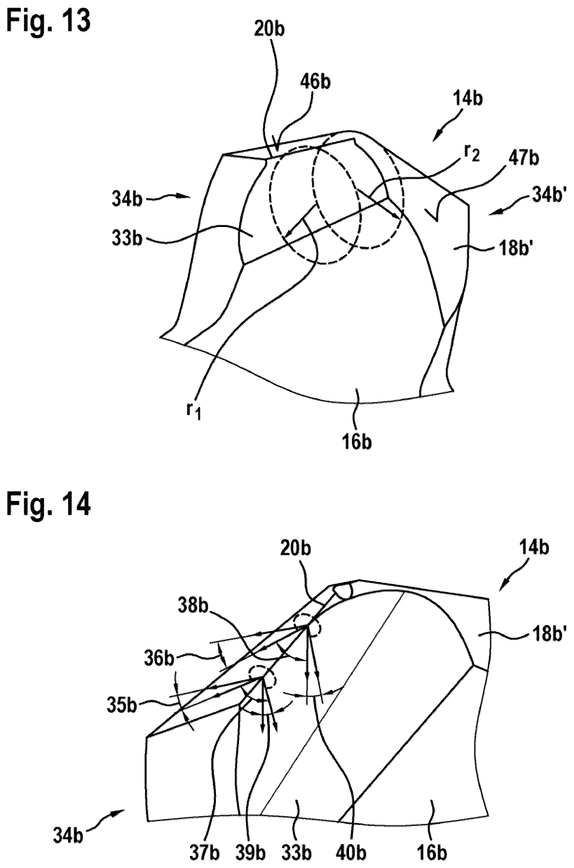

The radius r₁, r₂ of curvature of the further thinned regions 33b, 33′b is substantially smaller than the radius of concave curvature of the helical grooves 16b, 16′b. he radius r₁, r₂ of curvature of the further thinned regions 33b, 33′b is not constant and can change over the course. Preferably, the radius r₁, r₂ of curvature of the further thinned regions 33b, 33′b changes continuously. The radius r₁, r₂ of curvature of the further thinned regions 33b, 33′b is preferably at least essentially constant. The radius r₁, r₂ of curvature of the further thinned regions 33b, 33′bis less than 2 mm. The radius r₁, r₂ of curvature of the further thinned regions 33b, 33′b is less than 2 mm at any point along the main cutting element. Preferably, the radius r₁, r₂ of the curvature of the further thinned regions 33b, 33′b is less than 1.5 mm at any point along the main cutting element, and particularly preferably less than 1 mm. The radius r₁, r₂ of curvature of the further thinned regions 33b, 33′b is in each case between 0.75 mm and 0.9 mm. When viewed radially from the outside, the thinned regions 33b, 33′b each have a radius r₁ of curvature between 0.8 mm and 0.9 mm at 20% of the edge length of the respective main cutting element 20b, 20′b. Furthermore, the thinned regions 33b, 33′b, viewed radially from the outside, each have a radius r₂ of curvature between 0.7 mm and 0.9 mm at 60% of the edge length of the respective thinned region 33b, 33′b (see FIG. 13).

A tool shank 28b is connected to the cutting part 12b. The tool shank 28b may have the same diameter as the cutting part 12b. The tool shank 28b may be cylindrical and smooth or may have connecting elements designed to interact with a tool holder of a drill.

The cutting part 12b may have a core thickness between 10% and 25%, in particular between 15% and 20%, of the diameter 13b of the cutting part 12b. The cutting part 12b has a core thickness of 1.1 mm. The main cutting elements 20b, 20′b have a main cutting element offset between 10% and 20%, in particular between 12% and 17%, of the diameter 13b of the cutting part 12b. The main cutting elements 20b, 20′b have a main cutting element offset of 0.86 mm. A length of the auxiliary cutting elements 22b, 22′b is limited in particular by the size of the main cutting element offset. The auxiliary cutting elements 22b, 22′b have an auxiliary cutting element offset between 0% and 2.5% of the diameter 13b of the cutting part 12b. The auxiliary cutting elements 22b, 22′b have an auxiliary cutting element offset between 0.01 mm and 0.15 mm.

1. A drill including a cutting part which has a drill point and at least two helical grooves which extend from the drill point to an end of the cutting part opposite the drill point, and in the region of the drill point, each lead into a thinned region, wherein the thinned regions form a cross-grinding, and wherein the thinned regions each have an opening angle of less than 30°.

2. The drill as claimed in claim 1, wherein the helical grooves have a helix angle of more than 30° at least near the drill point.

3. The drill as claimed in claim 2, wherein the helical grooves have a helix angle of between 35° and 45°.

4. The drill according to claim 1, wherein the thinned regions each have an opening angle of between 18° and 28°.

5. The drill according to claim 1, wherein the thinned regions each have an opening angle of 27°.

6. The drill according to claim 1, wherein an auxiliary cutting element is formed in each of the thinned regions, wherein the drill defines a center axis, and wherein the auxiliary cutting element is arranged in between the main cutting element and the center axis.

7. The drill according to claim 6, wherein the auxiliary cutting element has a rake angle between 5° and 30°.

8. The drill according claim 1, wherein the drill point has a clearance angle of between 5° and 15°.

9. The drill according to claim 1, wherein the drill point has a cross cutting element having a length corresponding to 0% to 5% of a diameter of the cutting part.

10. The drill according to claim 1, wherein the drill defines a center axis, and wherein the drill point has at least one cross cutting element which extends at least substantially perpendicular to the center axis across the center axis.

11. The drill according to claim 6, wherein the auxiliary cutting elements are aligned at least substantially parallel to the cross cutting element, offset with respect to the cross cutting element.

12. The drill according to claim 1, wherein the drill point has at least two further thinned regions directly adjoining the main cutting element, which each form a partial rake face and are each curved concavely around an axis which extends at least substantially parallel to the respectively adjacent main cutting element.

13. The drill according to claim 12, wherein a radius of curvature of the further thinned regions is substantially smaller than a radius of concave curvature of the helical grooves.

14. The drill according to claim 12, wherein a radius of curvature of the further thinned regions is less than 2 mm.

15. The drill according to claim 12, wherein the further thinned regions each have a maximum thinned region length which is greater than a main cutting element length of the main cutting elements.

16. The drill as claimed in claim 1, wherein the drill is a twist drill or a step drill.
